(19) United States
(12) Patent Application Publication
(10) Pub. No.: US 2012/0063477 A1
(43) Pub. Date: Mar. 15, 2012

(54) LASER LIGHT SOURCE APPARATUS

(75) Inventors: Kohei SUYAMA, Fukuoka (JP); Hirohiko Oowaki, Fukuoka (JP); Tomohiro MATSUO, Fukuoka (JP)

(73) Assignee: PANASONIC CORPORATION, Osaka (JP)

(21) Appl. No.: 13/226,680

(22) Filed: Sep. 7, 2011

(30) Foreign Application Priority Data
Sep. 10, 2010 (JP) 2010-203049

(51) Int. Cl. H01S 3/13

(52) U.S. Cl. 372/32

(57) ABSTRACT

Angle adjustment of a wavelength conversion element after assembly is eliminated to achieve a reduction in production cost with a simplified structure. An element holder provided on a base that supports the wavelength conversion element is provided with a mounting reference surface that positions the wavelength conversion element in parallel with an optical axis. The wavelength conversion element has a substantially parallelepiped shape. A bottom surface, which is one of the four surfaces adjacent to an incident surface and an output surface, is in contact with the mounting reference surface, such that a depth direction of inverted polarization regions is substantially orthogonal to the optical axis and the incident surface and the output surface are tilted at a predetermined tilt angle relative to a flat surface orthogonal to the optical axis.

### CROSS-REFERENCE TO RELATED APPLICATIONS

The present application claims priority under 35 U.S.C. §119 of Japanese Application No. 2010-203049 filed on Sep. 10, 2010, the disclosure of which is expressly incorporated by reference herein in its entirety.

### BACKGROUND OF THE INVENTION

1. Field of the Invention

The present invention relates to a laser light source apparatus having a semiconductor laser, particularly to a laser light source apparatus used as a light source of an image display apparatus.

2. Description of Related Art

A technology recently drawing attention employs a semiconductor laser as a light source of an image display apparatus. Compared with mercury lamps conventionally widely used in image display apparatuses, the semiconductor laser has a variety of advantages, including good color reproducibility, instant light up, long life, high efficiency and a reduction in power consumption, and easy downsizing.

For such a laser light source apparatus used in an image display apparatus, there is no high-power semiconductor laser directly emitting green color laser light. A technology is thus known in which excitation laser light is output from a semiconductor laser; a laser medium is excited by the excitation laser light, so that infrared laser light is output; and a wavelength of the infrared laser light is converted by a wavelength conversion element, so that green color laser light is output. Such a technology is disclosed in Japanese Patent Laid-open Publication No. 2008-16833, for example.

In a green color laser light source apparatus having such a configuration above, laser light output changes according to an angle of a wavelength conversion element relative to an optical axis of laser light. It is thus preferred that the wavelength conversion element be placed at an angle at which the output is maximum. To this end, a configuration is desirable that allows adjustment of the angle of the wavelength conversion element as the output is being checked after assembly. The configuration, however, is complex and thus increases the cost.

### SUMMARY OF THE INVENTION

In view of the circumstances above, a main advantage of the present invention is to provide a laser light source apparatus configured to eliminate adjustment of an angle of a wavelength conversion element after assembly, thus reducing production cost with a simplified configuration.

Another advantage of the present invention is to provide a laser light source apparatus in which two surfaces facing each other in a depth direction of inverted polarization regions of a wavelength conversion element are electrically connected, such that the two surfaces are maintained at the same potential to prevent a change in a refractive index due to an increase in charge.

Another advantage of the present invention is to provide a laser light source apparatus in which a wavelength conversion element and a solid-laser element are positioned and integrated on the same mounting reference surface, thus eliminating adjustment of relative positions of the wavelength conversion element and the solid-laser element after assembly to reduce man-hours.

Another advantage of the present invention is to provide a laser light source apparatus eliminating individual mounting of a wavelength conversion element and a solid-laser element on an element holder to reduce man-hours.

Another advantage of the present invention is to provide a laser light source apparatus in which a material of an element holder is increased in thickness to increase a cut surface size so as to ensure a large bonding area for improvement in mounting accuracy of an element assembly.

Another advantage of the present invention is to provide a laser light source apparatus having enhanced heat dissipating performance to externally dissipate heat generated by a wavelength conversion element.

Another advantage of the present invention is to provide a laser light source apparatus increasing wavelength conversion efficiency of a wavelength conversion element to increase laser light output.

Another advantage of the present invention is to provide a laser light source apparatus outputting high-power green color laser light.

Another advantage of the present invention is to provide a laser light source apparatus.

In view of the advantages above, a laser light source apparatus according to the present invention includes an wavelength conversion element periodically provided with inverted polarization regions and a base supporting the wavelength conversion element through an element holder that holds the wavelength conversion element. The element holder is provided with a mounting reference surface that positions the wavelength conversion element in parallel with an optical axis. The wavelength conversion element has a substantially parallelepiped shape. One of four surfaces adjacent to an incident surface thereof and an output surface thereof is in contact with the mounting reference surface, such that a depth direction of the inverted polarization regions is substantially orthogonal to the optical axis and that the incident surface and the output surface are tilted relative to a flat surface orthogonal to the optical axis.

Thereby, the wavelength conversion element is disposed in contact with the mounting reference surface in the state where the incident surface and the output surface are tilted relative to the flat surface orthogonal to the optical axis. Accordingly, angle adjustment of the wavelength conversion element after assembly is eliminated, thus achieving a reduction in production cost with a simplified structure.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view of a configuration of an image display apparatus according to a first embodiment;

FIG. 2 is a schematic view illustrating a state of laser light in a green color laser light source apparatus;

FIG. 3 is a perspective view of the green color laser light source apparatus;

FIG. 4 is a schematic cross-sectional view of the green color laser light source apparatus;

FIG. 5 is a perspective view of a wavelength conversion element;

FIG. 6 is a schematic view illustrating a production process of the wavelength conversion element;

FIG. 7 illustrates a change state of a wavelength conversion efficiency according to a tilt angle of an incident surface and an output surface relative to a flat surface orthogonal to an optical axis direction;

FIG. 8 is a perspective view of an element holder;

FIG. 9 is a perspective view of an element holder according to a modification of the first embodiment of the present invention;

FIG. 10 is a cross-sectional view of the element holder in FIG. 9;

FIG. 11 is a perspective view of a green color laser light source apparatus according to a second embodiment of the present invention;

FIG. 12 is a schematic view illustrating a production process of the wavelength conversion element;

FIG. 13 is a perspective view of an element assembly according to a modification of the second embodiment of the present invention;

FIG. 14 is a perspective view of a green color laser light source apparatus according to a third embodiment of the present invention;

FIG. 15 is a schematic view illustrating a production process of an element assembly;

FIG. 16 is a perspective view of an element assembly according to a modification of the third embodiment of the present invention; and

FIG. 17 is a perspective view illustrating an example in which the image display apparatus is installed in a laptop information processing apparatus.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The embodiments of the present invention are explained below with reference to the drawings.

### First Embodiment

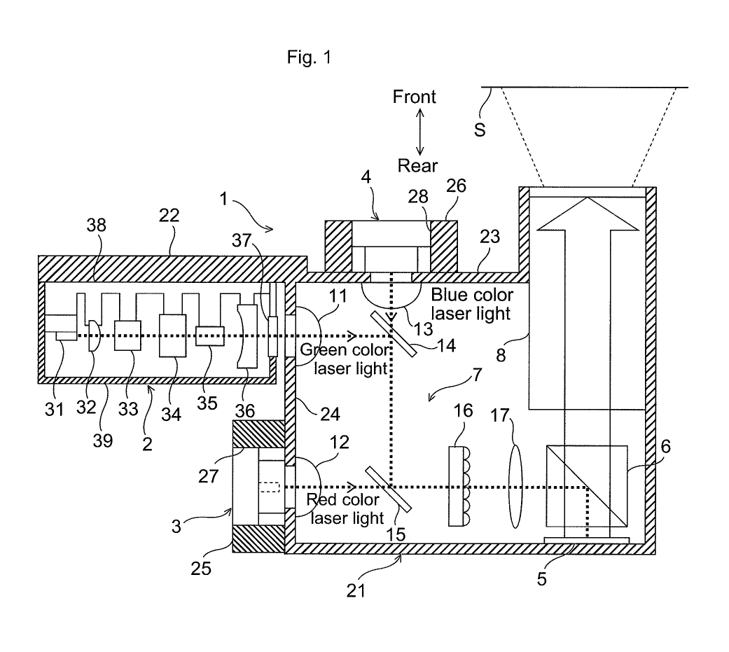

FIG. 1 is a schematic view of a configuration of an image display apparatus 1 according to a first embodiment of the present invention. The image display apparatus 1, which projects and displays a predetermined image on a screen, has a green color laser light source apparatus 2 emitting green color laser light; a red color laser light source apparatus 3 emitting red color laser light; a blue color laser light source apparatus 4 emitting blue color laser light; an LCD-reflective spatial light modulator 5 modulating the laser light emitted from each of the laser light source apparatuses 2 to 4, according to image signals; a polarization beam splitter 6 reflecting the laser light emitted from each of the laser light source apparatuses 2 to 4 and radiating the light onto the spatial light modulator 5, and transmitting the modulated laser light emitted from the spatial light modulator 5; a relay optical system 7 guiding the laser light emitted from each of the laser light source apparatuses 2 to 4 to the polarization beam splitter 6; and a projection optical system 8 projecting the modulated laser light that has transmitted the polarization beam splitter 6 on a screen. The image display apparatus 1 displays a color image in a commonly-called field sequential system. Laser light having respective colors is sequentially emitted from the respective laser light source apparatus 2 to 4 on a time division basis. Images of the laser light having respective colors are recognized as a color image due to a residual image effect.

The relay optical system 7 includes collimator lenses 11 to 13; a first dichroic mirror 14 and a second dichroic mirror 15; a diffuser panel 16; and a field lens 17. The collimator lenses 11 to 13 convert the laser light having respective colors into a parallel beam, the laser light being emitted from the laser light source apparatuses 2 to 4, respectively. The first dichroic mirror 14 and the second dichroic mirror 15 guide the laser light in a predetermined direction, the laser light having passed through the collimator lenses 11 to 13. The diffuser panel 16 diffuses the laser light guided by the dichroic mirrors 14 and 15. The field lens 17 converts the laser light having passed through the diffuser panel 16 into a converging laser.

When a side on which the laser light is emitted from the projection optical system 8 toward a screen S is a front side, the blue color laser light is emitted rearward from the blue color laser light source apparatus 4. The green color laser light is emitted from the green color laser light source apparatus 2 and the red color laser light is emitted from the red color laser light source apparatus 3, such that an optical axis of the green color laser light and an optical axis of the red color laser light orthogonally intersect with an optical axis of the blue color laser light. The blue color laser light, the red color laser light, and the green color laser light are guided to the same optical path by the two dichroic mirrors 14 and 15. Specifically, the blue color laser light and the green color laser light are guided to the same optical path by the first dichroic mirror 14; and the blue color laser light, the green color laser light, and the red color laser light are guided to the same optical path by the second dichroic mirror 15.

Each of the first dichroic mirror 14 and the second dichroic mirror 15 is provided with a film on a surface thereof, the film transmitting and reflecting laser light having a predetermined wavelength. The first dichroic mirror 14 transmits the blue color laser light and reflects the green color laser light. The second dichroic mirror 15 transmits the red color laser light and reflects the blue color laser light and the green color laser light. The optical members above are supported by a case 21. The case 21 functions as a heat dissipating body dissipating heat generated at the laser light source apparatuses 2 to 4. The case 21 is formed of a high thermal conductive material, such as aluminum or copper.

The green color laser light source apparatus 2 is mounted to a mounting portion 22, which is provided to the case 21 and projects to a side. The mounting portion 22 is provided projecting orthogonal to a side wall portion 24 from a corner portion at which a front wall portion 23 and the side wall portion 24 intersect, the front wall portion 23 being positioned in the front of a housing space of the relay optical system 7, the side wall portion 24 being positioned on the side of the housing space. The red color laser light source apparatus 3 is mounted on an external surface of the side wall portion 24 in a state being held by a holder 25. The blue color laser light source apparatus 4 is mounted on an external surface of the front wall portion 23 in a state being held by a holder 26.

The red color laser light source apparatus 3 and the blue color laser light source apparatus 4 are provided in a commonly-called can package, in which a laser chip emitting laser light is disposed, such that an optical axis is positioned on a central axis of a can-shaped external portion in a state where the laser chip is supported by a stem. The laser light is emitted through a glass window provided to an opening of the external portion. The red color laser light source apparatus 3 and the blue color laser light source apparatus 4 are press-fitted into attachment holes 27 and 28, respectively, which are provided in the holders 25 and 26, respectively. The red color laser light source apparatus 3 and the blue color laser light source apparatus 4 are thus fixed to the holders 25 and 26, respectively. Heat generated by the laser chips of the blue color laser light source apparatus 4 and the red color laser light source apparatus 3 is transferred through the holders 25 and 26, respectively, to the case 21 and dissipated. The holders 25 and 26 are formed of a high thermal conductive material, such as aluminum and copper.

The green color laser light source apparatus 2 includes a semiconductor laser 31; an FAC (fast-axis collimator) lens 32; a rod lens 33; a solid-laser element 34; a wavelength conversion element 35; a concave mirror 36; a glass cover 37; a base 38 supporting the components; and a cover body 39 covering the components. The semiconductor laser 31 emits excitation laser light. The FAC lens 32 is a collecting lens that collects the excitation laser light emitted from the semiconductor laser 31. The solid-laser element 34 emits fundamental laser light (infrared laser light) excited by the excitation laser light. The wavelength conversion element 35 converts the fundamental laser light and emits half wavelength laser light (green color laser light). The concave mirror 36 constitutes a resonator with the solid-laser element 34. The glass cover 37 prevents leak of the excitation laser light and fundamental wavelength laser light.

The base 38 of the green color laser light source apparatus 2 is fixed to the mounting portion 22 of the case 21. A space having a predetermined width (0.5 mm or less, for example) is provided between the green color laser light source apparatus 2 and the side wall portion 24 of the case 21. Thereby, the heat of the green color laser light source apparatus 2 becomes less likely to be transferred to the red color laser light source apparatus 3. The temperature of the red color laser light source apparatus 3 is then prevented from being increased. The red color laser light source apparatus 3, which has undesirable temperature properties, can thus be operated stably. Furthermore, in order to secure a predetermined margin for optical axis adjustment (approximately 0.3 mm, for example) of the red color laser light source apparatus 3, a space having a predetermined width (0.3 mm or more, for example) is provided between the green color laser light source apparatus 2 and the red color laser light source apparatus 3.

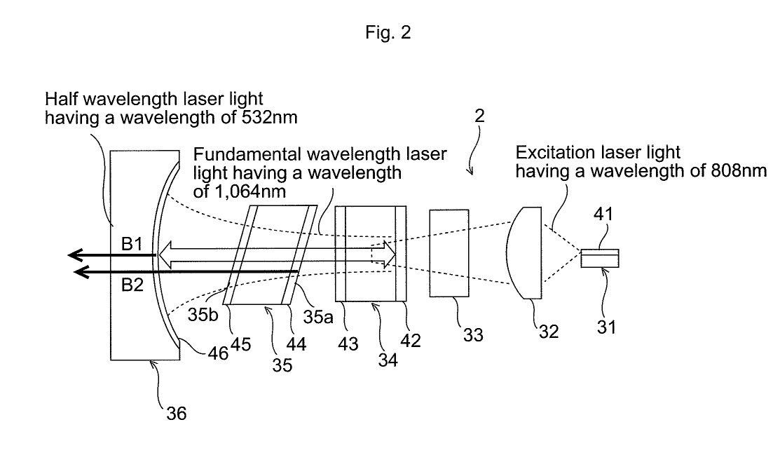

FIG. 2 is a schematic view illustrating a state of laser light in the green color laser light source apparatus 2. A laser chip 41 of the semiconductor laser 31 emits excitation laser light having a wavelength of 808 nm. The FAC lens 32 reduces expansion of a fast axis (direction orthogonal to an optical axis direction and along a paper surface of the drawing) of the laser light. The rod lens 33 reduces expansion of a slow axis (direction orthogonal to a paper surface of the drawing) of the laser light.

The solid-laser element 34 is excited by the excitation laser light having a wavelength of 808 nm and having passed through the rod lens 33, and emits fundamental wavelength laser light having a wavelength of 1,064 nm (infrared laser light). The solid-laser element 34 is an inorganic optically active substance (crystal) formed of, such as Y (yttrium) and VO₄ (vanadate), which is doped with Nd (neodymium). More specifically, Y of YVO₄ as a base martial is substituted and doped with Nd⁺³, which is an element producing fluorescence. A film 42 is provided to the solid-laser element 34 on a side opposite to the rod lens 33, the film 42 preventing reflection of the excitation laser light having a wavelength of 808 nm and highly reflecting the fundamental wavelength laser light having a wavelength of 1,064 nm and the half wavelength laser light having a wavelength of 532 nm. A film 43 is provided to the solid-laser element 34 on a side opposite to the wavelength conversion element 35, the film 43 preventing refection of the fundamental wavelength laser light having a wavelength of 1,064 nm and the half wavelength laser light having a wavelength of 532 nm.

The wavelength conversion element 35, which is a commonly-called SHG (Second Harmonics Generation) element, converts a wavelength of the fundamental wavelength laser light (infrared laser light) having a wavelength of 1,064 nm emitted from the solid-laser element 34, and generates the half wavelength laser light (green color laser light) having a wavelength of 532 nm. A film 44 is provided to the wavelength conversion element 35 on a side opposite to the solid-laser element 34, the film 44 preventing reflection of the fundamental wavelength laser light having a wavelength of 1,064 nm and highly reflecting the half wavelength laser light having a wavelength of 532 nm. A film 45 is provided to the wavelength conversion element 35 on a side opposite to the concave mirror 36, the film 45 preventing refection of the fundamental wavelength laser light having a wavelength of 1,064 nm and the half wavelength laser light having a wavelength of 532 nm.

The concave mirror 36 has a concave surface on a side opposite to the wavelength conversion element 35. The concave surface is provided with a film 46 highly reflecting the fundamental wavelength laser light having a wavelength of 1,064 nm and preventing reflection of the half wavelength laser light having a wavelength of 532 nm. Thereby, the fundamental wavelength laser light having a wavelength of 1,064 nm is resonated and amplified between the film 42 of the solid-laser element 34 and the film 46 of the concave mirror 36.

The wavelength conversion element 35 converts a portion of the fundamental wavelength laser light having a wavelength of 1,064 nm entering from the solid-laser element 34, to the half wavelength laser light having a wavelength of 532 nm. A portion of the fundamental wavelength laser light having a wavelength of 1,064 nm which is not converted and transmits the wavelength conversion element 35 is reflected by the concave mirror 36. The reflected fundamental wavelength laser light then re-enters the wavelength conversion element 35 and is converted to the half wavelength laser light having a wavelength of 532 nm. The half wavelength laser light having a wavelength of 532 nm is reflected by the film 44 of the wavelength conversion element 35 and emitted from the wavelength conversion element 35.

A laser beam B1 enters the wavelength conversion element 35 from the solid-laser element 34, is converted to a different wavelength at the wavelength conversion element 35, and is emitted from the wavelength conversion element 35. A laser beam B2 is once reflected by the concave mirror 36, enters the wavelength conversion element 35, is reflected by the film 44, and is emitted from the wavelength conversion element 35. In a state where the laser beam B1 and the laser beam B2 overlap, the half wavelength laser light having a wavelength of 532 nm and the fundamental wavelength laser light having a wavelength of 1,064 nm interfere and thus the output is reduced.

An incident surface 35a and an output surface 35b of the wavelength conversion element 35 are thus tilted relative to an flat surface orthogonal to an optical axis direction. Then, the laser beams B1 and B2 are prevented from overlapping each other by refraction of the incident surface 35a and the output surface 35b. Interference is thus prevented between the half wavelength laser light having a wavelength of 532 nm and the fundamental wavelength laser light having a wavelength of 1,064 nm, and thereby the output can be prevented from reducing. In order to prevent the excitation laser light having a wavelength of 808 nm and the fundamental wavelength laser light having a wavelength of 1,064 nm from leaking externally, a film not transmissive to the laser light is provided on the glass cover 37 shown in FIG. 1.

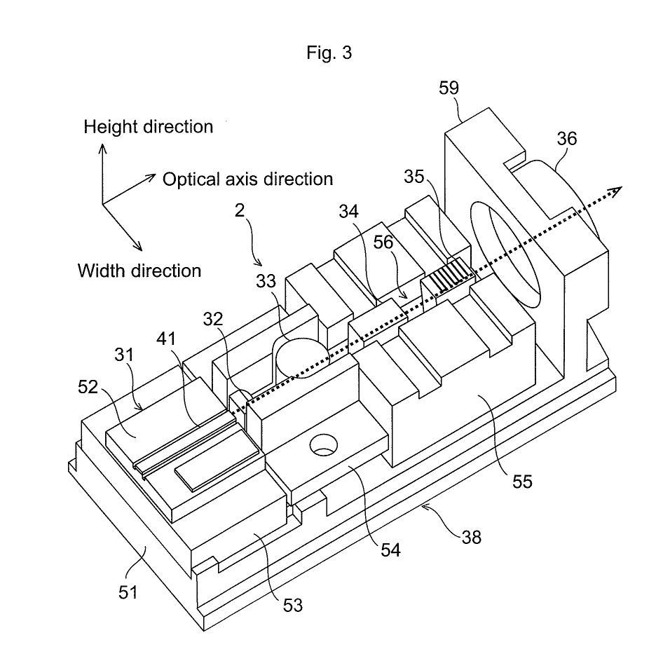

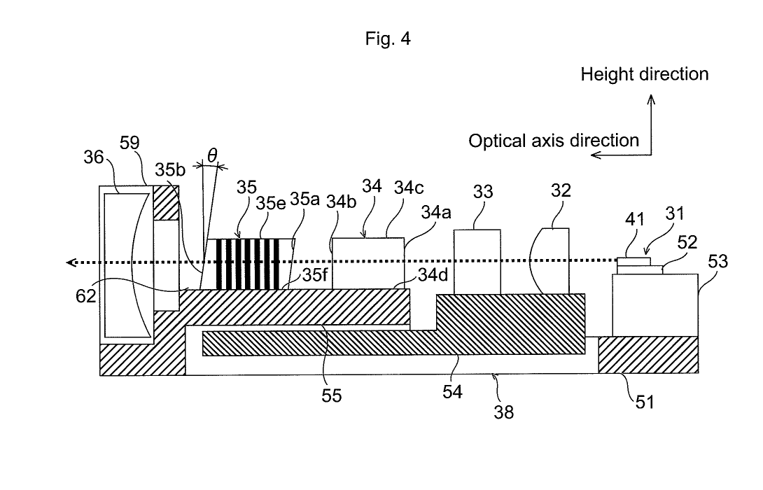

FIG. 3 is a perspective view of the green color laser light source apparatus 2. FIG. 4 is a schematic cross-sectional view of the green color laser light source apparatus 2. As shown in FIGS. 3 and 4, the semiconductor laser 31, the FAC lens 32, the rod lens 33, the solid-laser element 34, the wavelength conversion element 35, and the concave mirror 36 are integrally supported by the base 38. A bottom surface 51 of the base 38 is provided in parallel with the optical axis direction. A direction orthogonal to the bottom surface 51 of the base 38 is defined herein as a height direction; and a direction orthogonal to the height direction and the optical axis direction is defined as a width direction. It is explained that a side proximate to the bottom surface 51 of the base 38 is lower and a side opposite to the bottom surface 51 is upper. The direction, however, does not necessarily coincides with an upper/lower direction of an actual apparatus.

The semiconductor laser 31 has the laser chip 41 mounted on a mounting member 52, the laser chip 41 emitting laser light. The laser chip 41 has a long band shape in the optical axis direction. The laser chip 41 is fixedly attached to a substantially central position in the width direction on one surface of the plate-shaped mounting member 52, in a state in which a light emitting surface faces toward the FAC lens 32. The semiconductor laser 31 is fixed to the base 38 through a mounting member 53. The mounting member 53 is formed of a highly heat conductive metal, such as copper or aluminum, thus capable of dissipating heat generated by the laser chip 41 as being transferred to the base 38.

The FAC lens 32 and the rod lens 33 are held by a collecting lens holder 54. The collecting lens holder 54 is supported by the base 38 so as to be movable in the optical axis direction. The position of the collecting lens holder 54, specifically the FAC lens 32 and the rod lens 33, is adjusted in the optical axis direction. Before the position is adjusted, the FAC lens 32 and the rod lens 33 are fixed with an adhesive agent to the collecting lens holder 54. After the position is adjusted, the collecting lens holder 54 and the base 38 are fixed to each other with an adhesive agent.

The solid-laser element 34 and the wavelength conversion element 35 are held by an element holder 55 integrally provided to the base 38. The element holder 55 is provided with a groove-shaped element housing portion 56 that accommodates the solid-laser element 34 and the wavelength conversion element 35. An adhesive agent is filled between an internal surface of the element housing portion 56 and the solid-laser element 34 and the wavelength conversion element 35 so as to fix the solid-laser element 34 and the wavelength conversion element 35 to the element holder 55. The element holder 55 is explained in detail hereinafter. The element holder 55 may be provided separately from the base 38 and then be fixed to the base 38.

The concave mirror 36 is supported by a concave mirror support 59 integrally provided to the base 38. A UV curing adhesive agent is preferable as the adhesive agent used to fix the components above, for example, the solid-laser element 34 and the wavelength conversion element 35 and the element holder 55.

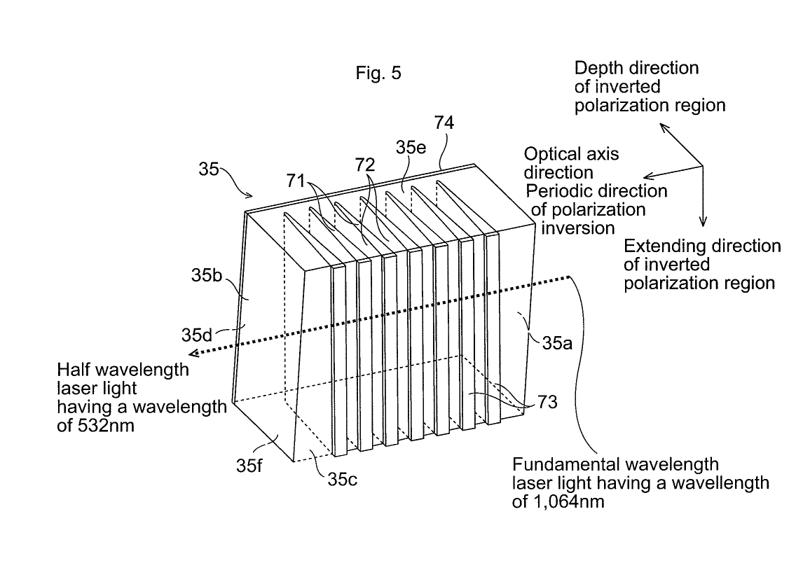

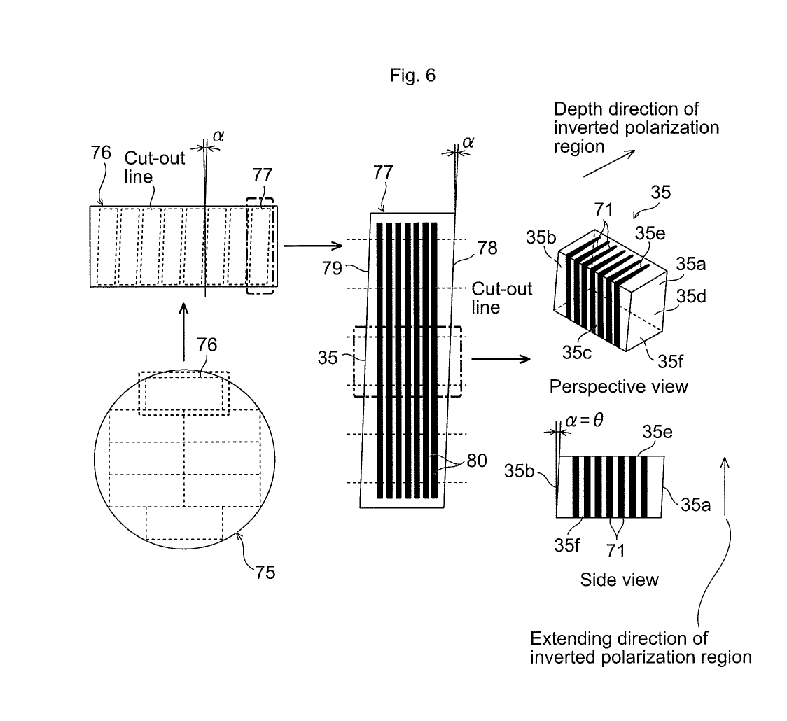

FIG. 5 is a perspective view of the wavelength conversion element 35. FIG. 6 is a schematic view illustrating a production process of the wavelength conversion element 35. As shown in FIG. 5, the wavelength conversion element 35 has a substantially cuboidal shape and has a periodic polarization inversion structure, in which inverted polarization regions 71 and non-inverted polarization regions 72 are alternately formed on a ferroelectric crystal. The wavelength conversion element 35 allows the fundamental wavelength laser light to enter in a periodic direction of polarization inversion (array direction of the inverted polarization regions 71). Thus, second-order harmonic generation of the incident light due to quasi phase matching provides doubled frequencies, specifically laser light having a half wavelength. The ferroelectric crystal is formed of LN (lithium niobate) added with MgO, for example.

In order to form a periodic polarization inversion structure, a periodic electrode 73 and an opposite electrode 74 are used to apply to a single-polarized ferroelectric crystal an electric field in a direction opposite to a polarization direction. Then, the polarization direction is inverted in a portion corresponding to the periodic electrode 73, and thereby the wedge-shaped inverted polarization regions 71 are formed from the periodic electrode 73 toward the opposite electrode 74. Practically, the wavelength conversion element 35 is produced in the process shown in FIG. 6. An electrode thin film is first laminated on a wafer 75 composed of a ferroelectric crystal. Then, an electrode pattern is formed by photolithography and etching. Subsequently, a substrate 76 is cut out from the wafer 75 on which the electrode pattern is formed, and is further cut into an appropriate size. Voltage is applied using an electrode to an produced strip stack 77 to invert polarization, and thus an polarization inversion structure is formed in the stack 77. End surfaces 78 and 79 of the stack 77 are optically polished, which will be provided as the incident surface 35a and the output surface 35b, respectively, of the wavelength conversion element 35. Then, a chip is cut out from the stack 77 to be provided as one wavelength conversion element 35.

Since the stack 77 is optically polished in a relatively large size, the stack 77 can be surely positioned to be optically polished, thus highly accurately ensuring the flatness and parallelism of the incident surface 35a and the output surface 35b. In addition, the stack 77 is cut out from the substrate 76 with a cut-out line tilted at a predetermined tilt angle α relative to an extending direction of the electrode pattern 80. The wavelength conversion element 35 is cut out from the stack 77 with a cut-out line orthogonal to the extending direction of the electrode pattern 80. Thereby, the incident surface 35a and the output surface 35b are tilted at the tilt angle α relative to a flat surface orthogonal to a top surface 35e and a bottom surface 35f, which are cut surfaces. Furthermore, an extending direction of the inverted polarization region is orthogonal to the top surface 35e and the bottom surface 35f. In a case of insufficient accuracy, polishing may be performed:

The wavelength conversion element 35 produced as above has a parallelepiped shape, in which, of three pairs of parallel planes, only one pair of parallel planes each have a parallelogram shape (excluding a rectangular shape) and the remaining two pairs of parallel planes each have a rectangular shape. Specifically, two side surfaces 35c and 35d facing each other in the depth direction of the inverted polarization region each have a parallelogram shape and the other surfaces each have a rectangular shape, the other surfaces including the incident surface 35a and the output surface 35b and the top surface 35e and the bottom surface 35f facing each other in the extending direction of the inverted polarization region. Although the incident surface 35a and the output surface 35b are precisely parallel, the two side surfaces 35c and 35d, the top surface 35e, and the bottom surface 35f are not necessarily precisely parallel. In FIG. 5, the periodic electrode 73 and the opposite electrode 74 are illustrated on the side surfaces 35c and 35d of the wavelength conversion element 35 for explanation purposes. The periodic electrode 73 and the opposite electrode 74 are removed in polishing at a stack stage.

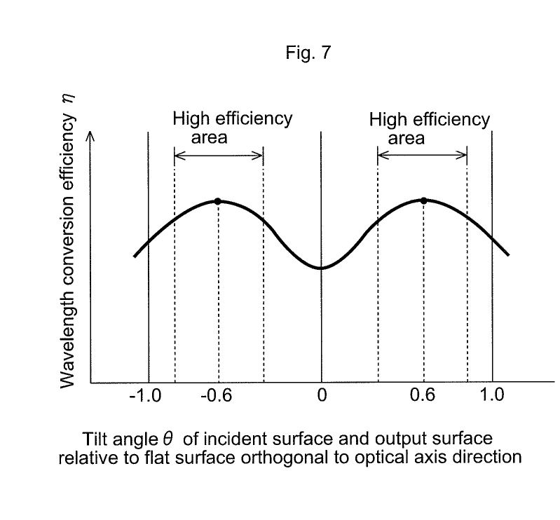

FIG. 7 illustrates a change state of a wavelength conversion efficiency T1 according to a tilt angle θ of the incident surface 35a and the output surface 35b relative to a flat surface orthogonal to an optical axis direction. The wavelength conversion efficiency 11 of the wavelength conversion element 35 changes according to the tilt angle θ of the incident surface 35a and the output surface 35b relative to the flat surface orthogonal to the optical axis direction. The wavelength conversion efficiency η is low in a state in which the incident surface 35a and the output surface 35b are not tilted (θ=0). Tilting the incident surface 35a and the output surface 35b increases the wavelength conversion efficiency η.

In the case where the tilt angle θ is 0, the laser beams B1 and B2 overlap each other, as shown in FIG. 2, and thus the half wavelength laser light having a wavelength of 532 nm and the fundamental wavelength laser light having a wavelength of 1,064 nm interfere. Tilting the incident surface 35a and the output surface 35b offsets the laser beams B1 and B2 due to refraction of the incident surface 35a and the output surface 35b, thus preventing output reduction due to interference.

The production accuracy and attachment accuracy of the wavelength conversion element 35 are ensured herein in particular by providing the incident surface 35a and the output surface 35b of the wavelength conversion element 35 tilted relative to the flat surface orthogonal to the optical axis direction as shown in FIG. 4, and by providing the tilt angle θ of the incident surface 35a and the output surface 35b within a predetermined range (e.g., ±0.4°) of a high efficiency area centering a peak point (θ=±0.6° herein) of the wavelength conversion efficiency shown in FIG. 7.

As shown in FIG. 5, the inverted polarization region 71 has a wedge shape having a thickness tapering along the depth direction. As the position of the wavelength conversion element 35 changes in the depth direction of the inverted polarization region 71 relative to an incident laser beam, a ratio of the inverted polarization region 71 and the non-inverted polarization region 72 changes which are positioned on a light path of the laser beam, and thus the wavelength conversion efficiency changes. Accordingly, the wavelength conversion element 35 is positioned in the depth direction of the inverted polarization region 71 such that the wavelength conversion efficiency is maximum, namely that the laser beam output is maximum.

Opposite to the illustrated example, a configuration may be considered in which the two surfaces 35e and 35f facing each other in the extending direction of the inverted polarization region each have a parallelogram shape. As shown in the illustrated example, however, in the case where the two surfaces 35c and 35d facing each other in the depth direction of the inverted polarization region each have a parallelogram shape, the laser beams B1 and B2 shown in FIG. 2 pass through a position which is identical in the depth direction of the inverted polarization region and is offset in the extending direction of the inverted polarization region. Thus, appropriately setting the position of the wavelength conversion element 35 in the depth direction of the inverted polarization region allows the laser beams B1 and B2 to pass through the position where the wavelength conversion efficiency is maximum, thus increasing the laser light output.

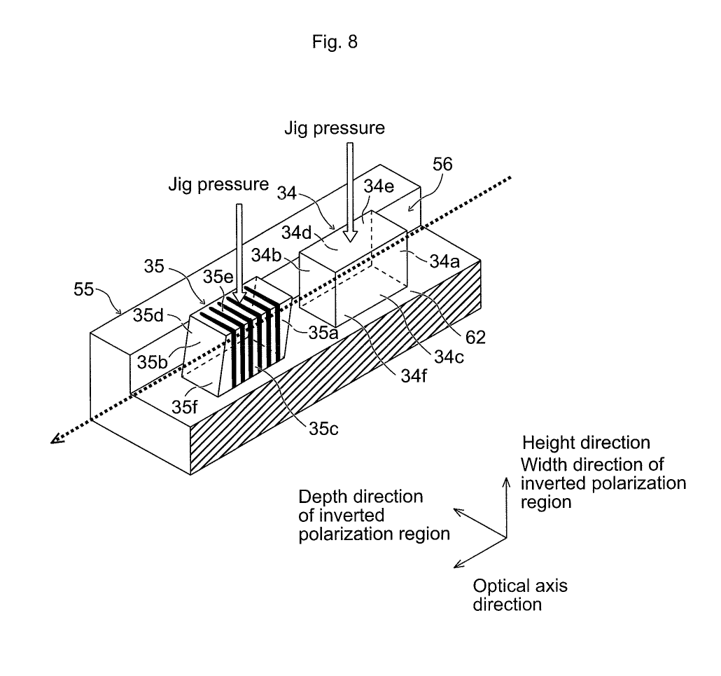

FIG. 8 is a perspective view of the element holder 55. In the element housing portion 56 of the element holder 55 that holds the solid-laser element 34 and the wavelength conversion element 35, a mounting reference surface 62 is provided on a flat surface in parallel with the optical axis, the mounting reference surface 62 positioning the solid-laser element 34 and the wavelength conversion element 35. The solid-laser element 34 has a substantially cuboidal shape. Of four surfaces 34c, 34d, 34e, and 34f adjacent to an incident surface 34a and an output surface 34b, the bottom surface 34f is in contact with the mounting reference surface 62 for positioning. The wavelength conversion element 35 has a substantially parallelepiped shape. Of four surfaces 35c, 35d, 35e, and 35f adjacent to the incident surface 35a and the output surface 35b, the bottom surface 35f is in contact with the mounting reference surface 62 for positioning, the bottom surface 35f being one of the two surfaces 35e and 35f in parallel with the depth direction of the inverted polarization region.

In assembly, the solid-laser element 34 and the wavelength conversion element 35 are pressed by a jig from sides opposite to the bottom surfaces 34f and 35f, respectively, so as to tightly attach the bottom surfaces 34f and 35f to the mounting reference surface 62. In this state, an adhesive agent is filled between an internal surface of the element housing portion 56 and the solid-laser element 34 and the wavelength conversion element 35. The adhesive agent is then cured so as to fix the solid-laser element 34 and the wavelength conversion element 35 on the element holder 55.

A conductive adhesive agent is used in particular as the adhesive agent filled between the side surfaces 35c and 35d of the wavelength conversion element 35. The element holder 55 is composed of a conductive material, such as a metal material. Thus, the side surfaces 35c and 35d of the wavelength conversion element 35 are electrically connected, and thereby the side surfaces 35c and 35d are maintained at the same potential so as to prevent a change in a refractive index due to an increase in charge. In the element holder 55 having such a configuration, the solid-laser element 34 and the wavelength conversion element 35 are positioned and integrated on the same mounting reference surface 62. It is thus no longer necessary to adjust relative positions of the solid-laser element 34 and the wavelength conversion element 35 after the assembly, thus reducing man-hours.

As shown in FIG. 6, the side surfaces 35c and 35d of the wavelength conversion element 35 are front and rear surfaces, respectively, of the wafer 75 on which the electrode pattern 80 is formed. The wavelength conversion element 35 is disposed such that the side surfaces 35c and 35d are provided substantially in parallel with the optical axis and face each other in the depth direction of the inverted polarization region. Thereby, the depth direction of the inverted polarization region is substantially orthogonal to the optical axis, enabling appropriate wavelength conversion.

### Modification of First Embodiment

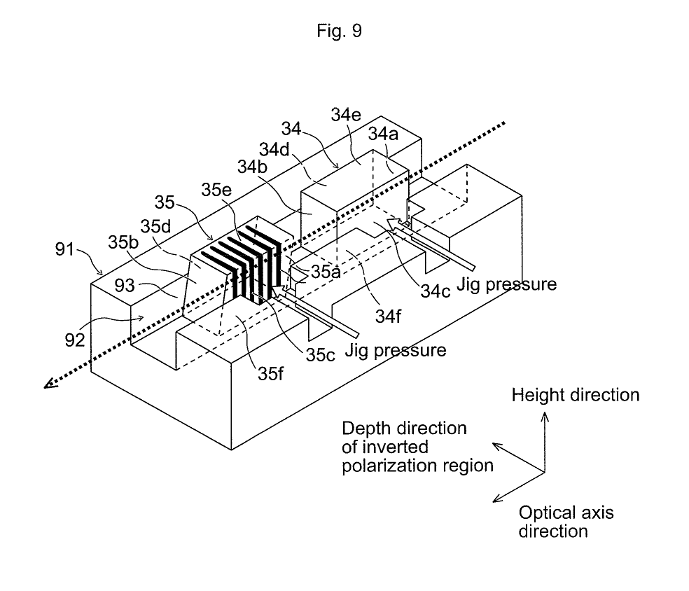

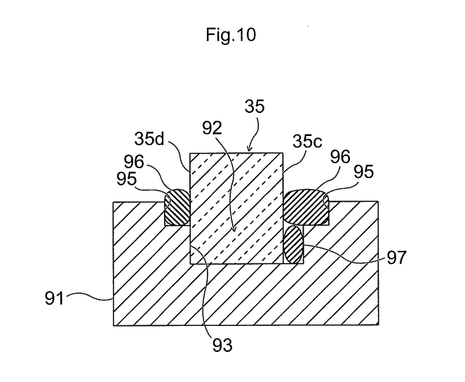

FIG. 9 is a perspective view of an element holder 91 according to a modification of the first embodiment of the present invention. FIG. 10 is a cross-sectional view of the element holder 91. Configurations of components are the same as those in the first embodiment unless otherwise particularly mentioned, and thus explanations thereof are omitted. As shown in FIG. 9, a mounting reference surface 93 that positions the solid-laser element 34 and the wavelength conversion element 35 is provided in parallel with an optical axis in an element housing portion 92 of the element holder 91 that holds the solid-laser element 34 and the wavelength conversion element 35. In the embodiment shown in FIGS. 4 and 8, the internal surface in parallel with the bottom surface 51 of the base 38 is the mounting reference surface 62. In the modification, however, the internal surface orthogonal to the bottom surface 51 of the base 38 is the mounting reference surface 93.

The solid-laser element 34 has a substantially cuboidal shape. Of the four surfaces 34c, 34d, 34e, and 34f adjacent to the incident surface 34a and the output surface 34b, the side surface 34d is in contact with the mounting reference surface 93 for positioning. The wavelength conversion element 35 has a substantially parallelepiped shape. Of the four surfaces 35c, 35d, 35e, and 35f adjacent to the incident surface 35a and the output surface 35b, the side surface 35d is in contact with the mounting reference surface 93 for positioning, the side surface 35d being one of the two side surfaces 35c and 35d substantially orthogonal to the depth direction of the inverted polarization region.

In assembly, the solid-laser element 34 and the wavelength conversion element 35 are pressed by a jig from sides opposite to the side surfaces 34d and 35d, respectively, so as to tightly attach the side surfaces 34d and 35d to the mounting reference surface 93. In this state, an adhesive agent is filled between an internal surface of the element housing portion 92 and the solid-laser element 34 and the wavelength conversion element 35. The adhesive agent is then cured so as to fix the solid-laser element 34 and the wavelength conversion element 35 on the element holder 91.

As shown in FIG. 10, the element holder 91 is provided with a recess 95 for filling the adhesive agent in a position opposite to side surfaces 35c and 35d of the wavelength conversion element 35. The recess 95 is filled with a conductive adhesive agent 96. The element holder 91 is composed of a conductive material, such as a metal material. Thus, the side surfaces 35c and 35d of the wavelength conversion element 35 are electrically connected, and thereby the side surfaces 35c and 35d are maintained at the same potential so as to prevent a change in a refractive index due to an increase in charge during polarization inversion. An adhesive agent 97 that fixes the element holder 91 and the wavelength conversion element 35 is filled in a space provided between the internal surface of the element housing portion 92 and the wavelength conversion element 35 on a side opposite to the mounting reference surface 93.

The first embodiment shown in FIG. 8 and the modification shown in FIG. 9 may be combined, specifically in which the mounting reference surface 62 and the mounting reference surface 93 are both provided, the mounting reference surface 62 being in parallel with the bottom surface 51 of the base 38 (in FIG. 3 and FIG. 4), the mounting reference surface 93 being orthogonal to the bottom surface 51 of the base 38. In this case, the bottom surfaces 34f and 35f of the solid-laser element 34 and the wavelength conversion element 35, respectively, are in contact with the mounting reference surface 62; and concurrently the side surfaces 34d and 35d of the solid-laser element 34 and the wavelength conversion element 35, respectively, are in contact with the mounting reference surface 93. Thereby, the solid-laser element 34 and the wavelength conversion element 35 are positioned in two directions.

In the configuration, angles of two surfaces adjacent to the incident surface 34a and the output surface 34b should be controlled in a production process of the solid-laser element 34, and angles of two surfaces adjacent to the incident surface 35a and the output surface 35b should be controlled in a production process of the wavelength conversion element 35. In an assembly process of the solid-laser element 34 and the wavelength conversion element 35, however, accuracy control of mounting angles of the solid-laser element 34 and the wavelength conversion element 35 by the jig can be eliminated since the solid-laser element 34 and the wavelength conversion element 35 are positioned in the two directions.

### Second Embodiment

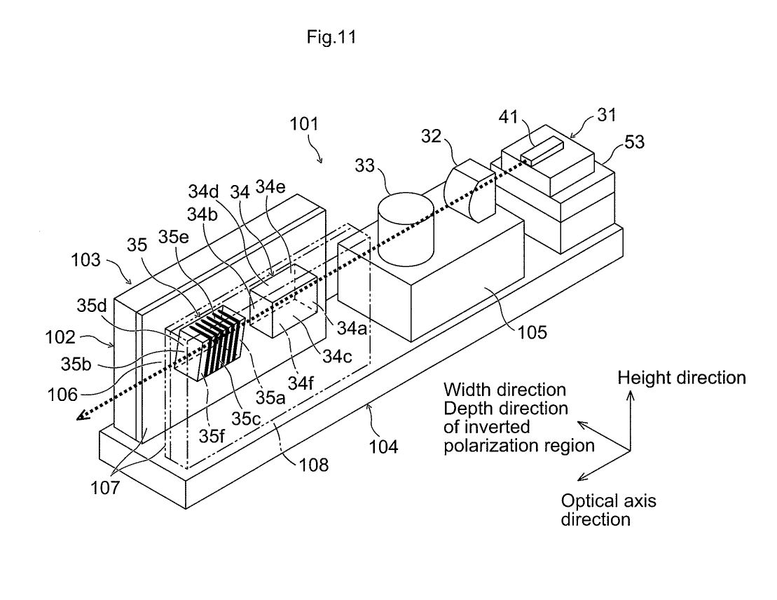

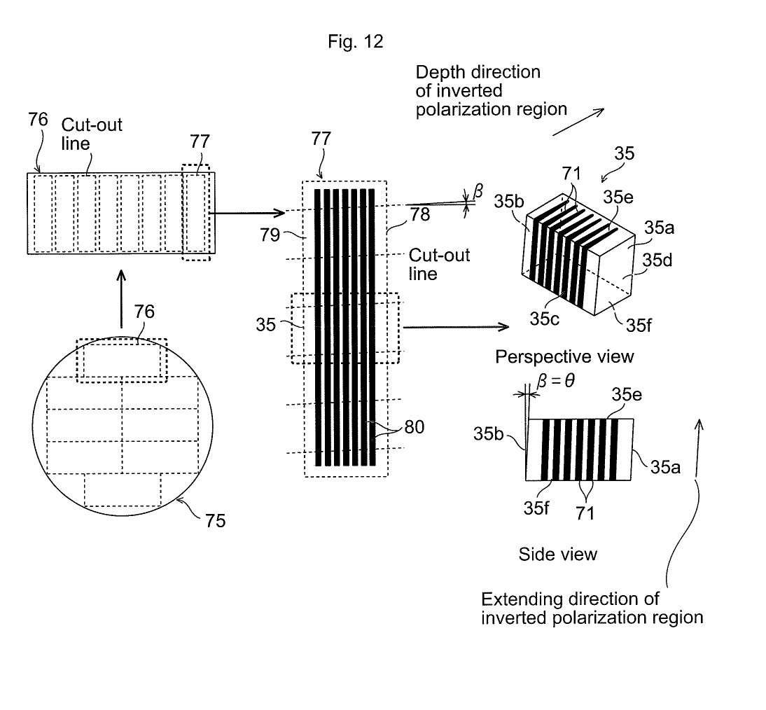

FIG. 11 is a perspective view of a green color laser light source apparatus 101 according to a second embodiment of the present invention. FIG. 12 is a schematic view illustrating a production process of the wavelength conversion element 35. Configurations of components are the same as those in the first embodiment unless otherwise particularly mentioned, and thus explanations thereof are omitted. As shown in FIG. 11, the solid-laser element 34 and the wavelength conversion element 35 are integrated by a planar element holder 102 that holds the components, thereby configuring an element assembly 103. The element holder 102 is fixed in a standing state on a base 104 disposed laterally.

The FAC lens 32 and the rod lens 33 are held by a collecting lens holder 105. The collecting lens holder 105 is supported by the base 104. The semiconductor laser 31 is supported by the base 104 through the mounting member 53.

In the element holder 102, one surface thereof serves as a mounting reference surface 106 concurrently positioning the solid-laser element 34 and the wavelength conversion element 35. The solid-laser element 34 has a substantially cuboidal shape. Of the four surfaces 34c, 34d, 34e, and 34f adjacent to the incident surface 34a and the output surface 34b, the side surface 34d is in contact with the mounting reference surface 106 for positioning. The wavelength conversion element 35 has a substantially parallelepiped shape. Of the four surfaces 35c, 35d, 35e, and 35f adjacent to the incident surface 35a and the output surface 35b, the side surface 35d is in contact with the mounting reference surface 106 for positioning, the side surface 35d being one of the two side surfaces 35c and 35d substantially orthogonal to the depth direction of the inverted polarization region.

The solid-laser element 34 and the wavelength conversion element 35 are fixedly attached to and integrated with the element holder 102 by an adhesive agent 107. In assembly, the solid-laser element 34 and the wavelength conversion element 35 are pressed by a jig from sides opposite to the side surfaces 34d and 35d, respectively, so as to tightly attach the side surfaces 34d and 35d with the mounting reference surface 106. In this state, the adhesive agent 107 is cured so as to fix the solid-laser element 34 and the wavelength conversion element 35 on the element holder 102.

In particular, a cover 108 is in contact with a surface on the opposite side to the element holder 102 in the solid-laser element 34 and the wavelength conversion element 35. The cover 108 is fixedly attached to the solid-laser element 34 and the wavelength conversion element 35 by the adhesive agent 107. In assembly, the adhesive agent 107 may be cured in a state in which the solid-laser element 34 and the wavelength conversion element 35 are interposed between the element holder 102 and the cover 108, so that the solid-laser element 34, the wavelength conversion element 35, the element holder 102, and the cover 108 are concurrently fixed.

The element holder 102 and the cover 108 are composed of a metal material having a low heat resistance, such as, for example, copper, aluminum, or an alloy mainly composed of copper and aluminum. Thus, heat dissipating performance can be increased in which heat generated by the solid-laser element 34 and the wavelength conversion element 35 is dissipated to the base 104. The efficiency of the solid-laser element 34 and the wavelength conversion element 35 is reduced along with a temperature increase. Increasing the heat dissipating performance can thus prevent a reduction in efficiency with the temperature increase.

In addition, the element holder 102 and the cover 108 are conductive; the adhesive agent 107 is a conductive adhesive agent; and the base 104, to which the element holder 102 and the cover 108 are connected, is composed of a conductive material, such as a metal material, thus functioning as a conductor that electrically connects the element holder 102 and the cover 108. Thereby, the side surfaces 35c and 35d of the wavelength conversion element 35 are electrically connected, and the side surfaces 35c and 35d are maintained at the same potential so as to prevent a change in a refractive index due to an increase in charge during polarization inversion.

In assembly of the solid-laser element 34 and the wavelength conversion element 35 to the element holder 102, a bonding device (die bonder) is preferably used, since the solid-laser element 34 and the wavelength conversion element 35 can be precisely mounted on the element holder 102.

As described above, the wavelength conversion efficiency changes according to the position of the wavelength conversion element 35 in the depth direction of the inverted polarization region. It is thus preferred that the position of the wavelength conversion element 35 be adjusted in the depth direction of the inverted polarization region in order to increase the laser light output. To meet the demand, the element assembly 103 may be configured to be movable in the width direction relative to the base 104.

In the first embodiment shown in FIG. 8, the extending direction of the inverted polarization region in the wavelength conversion element 35 is tilted relative to the incident surface 35a and the output surface 35b and is orthogonal to the top surface 35e and the bottom surface 35f, namely orthogonal to the optical axis direction. In the second embodiment shown in FIG. 11, however, the extending direction of the inverted polarization region is in parallel with the incident surface 35a and the output surface 35b and is tilted relative to the flat surface orthogonal to the optical axis direction. The wavelength conversion element 35 having such a configuration can be produced in a process shown in FIG. 12.

The wavelength conversion element 35 is cut out from the stack 77 with a cut-out line tilted at a predetermined tilt angle β relative to a direction orthogonal to the extending direction of the electrode pattern 80. The tilt β angle is identical to the tilt angle θ (e.g., 0.6°±0.4°) of the incident surface 35a and the output surface 35b relative to the flat surface orthogonal to the optical axis direction. Furthermore, the stack 77 is cut out from the substrate 76 with a cut-out line orthogonal to the extending direction of the electrode pattern 80. Thereby, the incident surface 35a and the output surface 35b are tilted relative to the flat surface orthogonal to the top surface 35e and the bottom surface 35f, which are cut surfaces. The extending direction of the inverted polarization region 71 provided along the electrode pattern 80 is not orthogonal to the top surface 35e and the bottom surface 35f and is parallel with the incident surface 35a and the output surface 35b.

### Modification of Second Embodiment

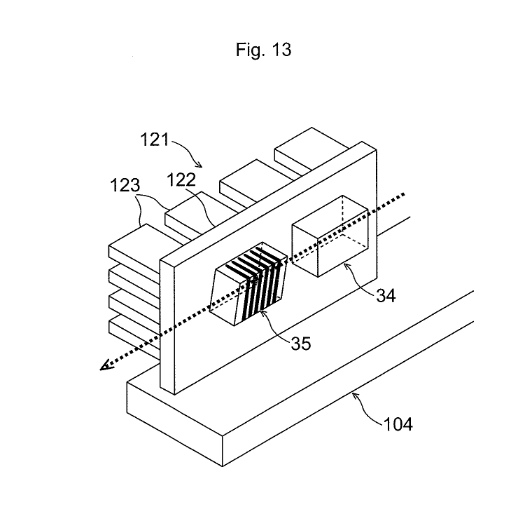

FIG. 13 is a perspective view of an element assembly 121 according to a modification of the second embodiment of the present invention. Configurations of components are the same as those in the first embodiment unless otherwise particularly mentioned, and thus explanations thereof are omitted. Similar to the second embodiment shown in FIG. 11, an element holder 122 that holds the solid-laser element 34 and the wavelength conversion element 35 is fixed in a standing state on the base 104 disposed laterally. In the modification, however, heat dissipating fins 123 are provided on a rear surface of the element holder 122, specifically on the side opposite to the solid-laser element 34 and the wavelength conversion element 35. This facilitates heat dissipation from the element holder 122 and enhances the heat dissipating performance.

### Third Embodiment

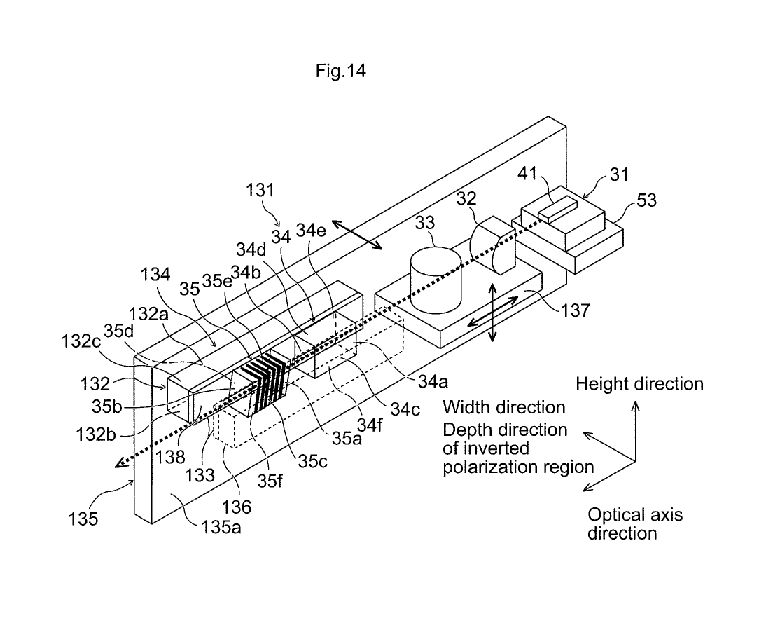

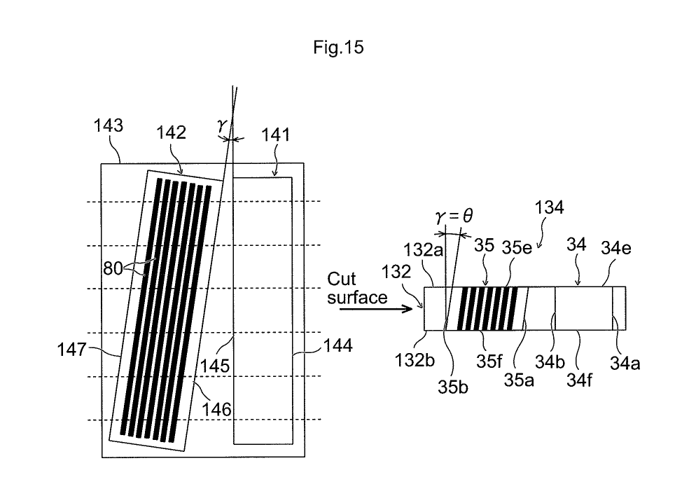

FIG. 14 is a perspective view of a green color laser light source apparatus 131 according to a third embodiment of the present invention. FIG. 15 is a schematic view illustrating a production process of an element assembly 134. Configurations of components are the same as those in the first embodiment unless otherwise particularly mentioned, and thus explanations thereof are omitted.

As shown in FIG. 14, the green color laser light source apparatus 131 has the element assembly 134 in which the solid-laser element 34 and the wavelength conversion element 35 are fixedly attached to and integrated with an element holder 132 by an adhesive agent 133, similar to the second embodiment. As shown in FIG. 15, the element assembly 134 is produced by fixedly attaching a stack 141 of the solid-laser element 34 and a stack 142 of the wavelength conversion element 35 to a single substrate 143 to be provided as the element holder 132, and then by cutting the stack 141 of the solid-laser element 34 and the stack 142 of the wavelength conversion element 35 together.

The stack 141 of the solid-laser element 34 has side surfaces 144 and 145 polished to be in parallel with each other, the side surfaces 144 and 145 being provided as the incident surface 34a and the output surface 34b, respectively. The stack 142 of the wavelength conversion element 35 also has side surfaces 146 and 147 polished to be in parallel with each other, the side surfaces 146 and 147 being provided as the incident surface 35a and the output surface 35b, respectively. The side surfaces 146 and 147 of the stack 142 of the wavelength conversion element 35 are cut out in parallel with the extending direction of the electrode pattern 80, similar to the example shown in FIG. 12.

The substrate 143 is a planar material composed of copper, aluminum, or the like. The stack 141 of the solid-laser element 34 and the stack 142 of the wavelength conversion element 35 are mounted by bonding on the substrate 143. At this time, the side surfaces 146 and 147 of the stack 142 of the wavelength conversion element 35 are mounted so as to be tilted at a predetermined tilt angle γ relative to the side surfaces 144 and 145 of the stack 141 of the solid-laser element 34, and are then cut along a cut-off line orthogonal to the side surfaces 144 and 145 of the stack 141 of the solid-laser element 34.

The tilt angle γ of the stack 142 of the wavelength conversion element 35 is identical to the tilt angle θ (e.g., 0.6°±0.4°) of the incident surface 35a and the output surface 35b relative to the flat surface orthogonal to the optical axis direction. As shown in FIG. 14, the element assembly 134 is disposed on a base 135 such that cut surfaces 132a and 132b of the element holder 132, the top surface 34e and the bottom surface 34f of the solid-laser element 34, and the top surface 35e and the bottom surface 35f of the wavelength conversion element 35 are in parallel to the optical axis direction. Then, the incident surface 34a and the output surface 34b of the solid-laser element 34 are orthogonal to the optical axis direction, and the incident surface 35a and the output surface 35b of the wavelength conversion element 35 are tilted at the predetermined tilt angle θ relative to the flat surface orthogonal to the optical axis direction.

As described above, the stack 141 of the solid-laser element 34 and the stack 142 of the wavelength conversion element 35 are integrated on the substrate 143 to be provided as the element holder 132 and are then cut, thus eliminating individual mounting of the solid-laser element 34 and the wavelength conversion element 35 on the element holder 132 and reducing man-hours. In addition, the solid-laser element 34 and the wavelength conversion element 35 are mounted on the substrate 143 in the state of the stacks 141 and 142, respectively, which are relatively large, thus enhancing mounting accuracy of the solid-laser element 34 and the wavelength conversion element 35 to the element holder 132.

In the embodiment shown in FIG. 14, the cover 136 is in contact with a surface on the opposite side to the element holder 132 in the solid-laser element 34 and the wavelength conversion element 35, similar to the second embodiment shown in FIG. 11. In this case, as shown in FIG. 15, a substrate to be provided as the cover 136 may be fixedly attached to the stack 141 of the solid-laser element 34 and the stack 142 of the wavelength conversion element 35 along with the substrate 143 to be provided as the element holder 132, and be cut together so as to reduce man-hours.

As shown in FIG. 14, the third embodiment is different from the second embodiment shown in FIG. 11 in the positional relationship of the element assembly 134 and the base 135. Specifically, the base 104 is disposed laterally and the element holder 102 is fixed to the base 104 in a standing state in the second embodiment shown in FIG. 11. In the third embodiment shown in FIG. 14, however, the base 135 is disposed vertically and the element assembly 134 is fixed to the base 135 in the state in which a surface 132c of the element holder 132 is in contact with a surface 135a of the base 135, the surface 132c being provided on the side opposite to the solid-laser element 34 and the wavelength conversion element 35.

The FAC lens 32 and the rod lens 33 are held by a collecting lens holder 137 and are integrally supported by the base 135 along with the solid-laser element 34 and the wavelength conversion element 35. The semiconductor laser 31 may be supported by the base 135. Alternatively, it may be supported by a separate base material along with the base 135.

The base 135 may be configured to be movable in the width direction relative to the semiconductor laser 31, and thereby the position of the wavelength conversion element 35 can be adjusted in the depth direction of the inverted polarization region to maximize the wavelength conversion efficiency. The collecting lens holder 137 of the FAC lens 32 and the rod lens 33 may be configured to be movable in the optical axis and height directions relative to the base 135, and thereby the distance and height position of the FAC lens 32 relative to the semiconductor laser 31 can be adjusted.

### Modification of Third Embodiment

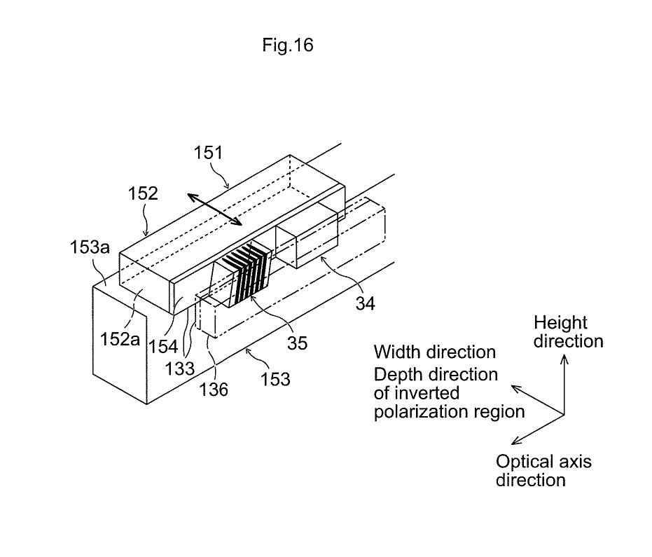

FIG. 16 is a perspective view of an element assembly 151 according to a modification of the third embodiment of the present invention. Configurations of components are the same as those in the first embodiment unless otherwise particularly mentioned, and thus explanations thereof are omitted.

As illustrated in FIG. 15, in the case where the stack 141 of the solid-laser element 34 and the stack 142 of the wavelength conversion element 35 are concurrently cut to produce the element assembly 134, the height of the element holder 132 is reduced according to the height of the solid-laser element 34 and the wavelength conversion element 35. In the case where the surface 132c of the element holder 132, which is on the side opposite to the mounting reference surface 138 with which the solid-laser element 34 and the wavelength conversion element 35 are in contact, is contacted with and fixed to the vertically disposed base 135, as shown in FIG. 14, the bonding area cannot be secured sufficiently, thus possibly degrading the mounting accuracy of the element assembly 134.

In order to address the circumstance, the width of a element holder 152 is increased as shown in FIG. 16. To this end, the thickness of the substrate to be provided as the element holder 152 is increased. Then, a lower surface 152a, which is a cut surface provided in cutting the substrate to be provided as the element holder 152, is contacted with an upper surface 153a of a base 153, and thus the element holder 152 is fixed to the base 153. Thereby, a large bonding area can be ensured, thus increasing the mounting accuracy of the element assembly 151.

The lower surface 152a of the element holder 152 and the upper surface 153a of the base 153 are provided in parallel in the depth direction of the inverted polarization region of the wavelength conversion element 35. The lower surface 152a of the element holder 152 is slid on the upper surface 153a of the base 153, and thereby the wavelength conversion element 35 is moved in the depth direction of the inverted polarization region. Accordingly, the position of the wavelength conversion element 35 can be adjusted to maximize the wavelength conversion efficiency. It is preferred that an appropriate regulator, such as guide groove, be provided in the element holder 152 and the base 153 to prevent the optical axis direction of the wavelength conversion element 35 from being displaced during the position adjustment.

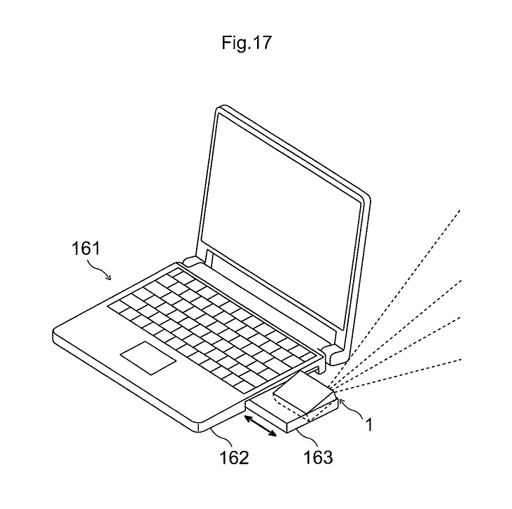

FIG. 17 is a perspective view illustrating an example in which the image display apparatus 1 is installed in a laptop information processing apparatus 161. A space to retractably store the image display apparatus 1 is provided in a case 162 of the information processing apparatus 161 on a rear side of a keyboard. When not being used, the image display apparatus 1 is stored in the case 162. When being used, the image display apparatus 1 is pulled out of the case 162 and rotated by a predetermined angle relative to a base 163 that rotatably supports the image display apparatus 1. Thereby, the laser light from the image display apparatus 1 can be projected on the screen.

In the embodiments above, the laser chip 41 of the green color laser light source apparatus 2, the solid-laser element 34, and the wavelength conversion element 35 output the excitation laser light having a wavelength of 808 nm, the fundamental wavelength laser light having a wavelength of 1,064 nm (infrared laser light), and the half wavelength laser light having a wavelength of 532 nm (green color laser light), respectively. The present invention, however, is not limited to the laser light output. It is acceptable provided that the laser light output finally from the green color laser light source apparatus 2 is identified as green. The laser light may be output in a wavelength range having a peak wavelength of 500 nm to 560 nm, for example.

In the embodiments above, the mounting reference surface 62, 93, 106, and 138 each positioning the wavelength conversion element 35 are each provided as one flat surface on which one surface of each of the solid-laser element 34 and the wavelength conversion element 35 is in contact with the entire surface, as shown in FIGS. 8, 9, 11, and 14. Instead, three projections having the same height may be provided in a position on which the mounting reference surface is provided, such that top surfaces of the projections serve as mounting reference surfaces that position the solid-laser element 34 and the wavelength conversion element 35. In this configuration, the solid-laser element 34 and the wavelength conversion element 35 are supported by three points.

In the case where the mounting reference surface is provided as one flat surface as in the embodiments above, there is a limit to improvement in flatness accuracy of the mounting reference surface. Slight instability is thus unavoidable in the solid-laser element 34 and the wavelength conversion element 35. In this case, the mounting angle is not determined to be one for the solid-laser element 34 and the wavelength conversion element 35. It is difficult to estimate a change in the angle due to instability of the solid-laser element 34 and the wavelength conversion element 35, thus causing variations in the mounting angle of the solid-laser element 34 and the wavelength conversion element 35. Furthermore, shrinkage of the adhesive agent varies in curing, thus increasing variations in the mounting angle of the solid-laser element 34 and the wavelength conversion element 35.

In this regard, the three-point support configuration of the solid-laser element 34 and the wavelength conversion element 35 by the three projections prevents instability in the solid-laser element 34 and the wavelength conversion element 35, thus stably supporting the solid-laser element 34 and the wavelength conversion element 35. In addition, with less susceptibility to impacts of variation factors, such as a dent, a pinched-in foreign object, and deformation of a component, variations are reduced in the mounting angle of the solid-laser element 34 and the wavelength conversion element 35. Accordingly, the yield can be improved.

A variety of featured configurations are illustrated in the embodiments. The configurations, however, are not applied only to the illustrated embodiments, and may be appropriately combined with the configurations in the other embodiments unless there is any particular disadvantage.

The laser light source apparatus according to the present invention eliminates angle adjustment of the wavelength conversion element after assembly, thus achieving a reduction in production cost with the simplified structure. It is effective as a laser light source apparatus used as a light source of an image display apparatus.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A laser light source apparatus comprising:
an wavelength conversion element periodically provided with inverted polarization regions;
an element holder holding the wavelength conversion element; and
a base supporting the wavelength conversion element through the element holder,
the element holder having a mounting reference surface in parallel with an optical axis, the element holder positioning the wavelength conversion element,
the wavelength conversion element having a substantially parallelepiped shape, wherein
one of four surfaces adjacent to an incident surface thereof and an output surface thereof is in contact with the mounting reference surface,
a depth direction of the inverted polarization regions of the wavelength conversion element is substantially orthogonal to the optical axis, and
the depth direction of the inverted polarization regions of the wavelength conversion element is disposed such that the incident surface and the output surface are tilted relative to a flat surface orthogonal to the optical axis.

2. The laser light source apparatus according to claim 1, wherein the wavelength conversion element is positioned by contacting, with the mounting reference surface, one of two surfaces substantially in parallel with the depth direction of the inverted polarization regions.

3. The laser light source apparatus according to claim 1, wherein the wavelength conversion element is positioned by contacting, with the mounting reference surface, one of two surfaces substantially orthogonal to the depth direction of the inverted polarization regions.

4. The laser light source apparatus according to claim 3, wherein
the wavelength conversion element has a cover in contact with a surface on a side opposite to the element holder, and
the element holder and the cover are composed of a conductive material and are electrically connected to each other through a conductor.

5. The laser light source apparatus according to claim 1, further comprising:
a solid-laser element excited by excitation laser light and outputting fundamental wavelength laser light,
the solid-laser element having a substantial cuboid shape, wherein
the mounting reference surface positions the solid-laser element along with the wavelength conversion element,
one of the four surfaces adjacent to the incident surface and the output surface is in contact with the mounting reference surface, and
the incident surface and the output surface are disposed orthogonal to the optical axis.

6. The laser light source apparatus according to claim 5, further comprising:
an element assembly integrally provided by fixedly attaching the wavelength conversion element, the solid-laser element, and the element holder to one another, wherein
the element assembly is produced by fixedly attaching a material of the wavelength conversion element, a material of the solid-laser element, and a material of the element holder to one another, and then cutting them together.

7. The laser light source apparatus according to claim 6, wherein the element holder is fixed by contacting a cut surface of the materials to the base.

8. The laser light source apparatus according to claim 1, wherein
the wavelength conversion element has a cover in contact with the surface on the side opposite to the element holder, and
the element holder and the cover are composed of a material having a low heat resistant.

9. The laser light source apparatus according to claim 1, wherein the element holder has a heat dissipating fin on a side opposite to a surface in contact with the wavelength conversion element.

10. The laser light source apparatus according to claim 1, wherein a tilt angle of the incident surface and the output surface is set to within a range of 0.6°±0.4° relative to the flat surface orthogonal to the optical axis of the wavelength conversion element.

11. The laser light source apparatus according to claim 1, further comprising:
a semiconductor laser outputting excitation laser light; and
a solid-laser element excited by the excitation laser light output from the semiconductor laser and outputting infrared laser light, wherein
the wavelength conversion element converts a wavelength of the infrared laser light output from the solid-laser element and outputs green color laser light.

12. A laser light source apparatus comprising:
a solid-laser element excited by excitation laser light and outputting fundamental wavelength laser light;
an wavelength conversion element periodically provided with inverted polarization regions;
an element holder holding the solid-laser element and the wavelength conversion element; and
a base supporting the wavelength conversion element through the element holder,
the element holder having an element housing portion that houses the solid-laser element and the wavelength conversion element having two internal surfaces in parallel with an optical axis and orthogonal to each other, one of the two internal surfaces serving as a mounting reference surface,
the solid-laser element having a substantial cuboid shape and being disposed by contacting, with the mounting reference surface, at least one of four surfaces adjacent to an incident surface thereof and an output surface thereof such that the incident surface and the output surface are orthogonal to the optical axis,
the wavelength conversion element having a substantial parallelpiped shape and being disposed by contacting, with the mounting reference surface, at least one of four surfaces adjacent to an incident surface and an output surface thereof such that the depth direction of the inverted polarization regions is substantially orthogonal to the optical axis and that the incident surface and the output surface are tilted relative to a flat surface orthogonal to the optical axis.

13. The laser light source apparatus according to claim 12, wherein the wavelength conversion element is positioned by contacting, with the mounting reference surface, one of two surfaces substantially parallel in the depth direction of the inverted polarization regions.

14. The laser light source apparatus according to claim 12, wherein the wavelength conversion element is positioned by contacting, with the mounting reference surface, one of two surfaces substantially orthogonal to the depth direction of the inverted polarization regions.

15. The laser light source apparatus according to claim 12, wherein
the wavelength conversion element has a cover in contact with a surface opposite to the internal surfaces of the element holder in the depth direction of the inverted polarization regions, and
the element holder and the cover are composed of a conductive material and are electrically connected to each other through a conductor.

16. The laser light source apparatus according to claim 12, wherein
the wavelength conversion element has a cover in contact with a surface on a side opposite to the internal surface of the element housing portion in the depth direction of the inverted polarization region, and
the element holder and the cover are composed of a material having a low heat resistance.

17. The laser light source apparatus according to claim 12, wherein the element holder has a heat dissipating fin on a side opposite to the internal surface of the element housing portion in contact with the wavelength conversion element.

18. The laser light source apparatus according to claim 12, wherein a tilt angle of the incident surface and the output surface is set to within a range of 0.6°±0.4° relative to the flat surface orthogonal to the optical axis of the wavelength conversion element.

19. The laser light source apparatus according to claim 12, further comprising:
a semiconductor laser outputting excitation laser light; and
a solid-laser element excited by the excitation laser light output from the semiconductor laser and outputting infrared laser light, wherein
the wavelength conversion element converts a wavelength of the infrared laser light output from the solid-laser element and outputs green color laser light.
